(19) United States
(12) Patent Application Publication
(10) Pub. No.: US 2026/0171723 A1
(43) Pub. Date: Jun. 18, 2026

(54) Connector Assembly and Male Connector and Female Connector Thereof

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/417,212

(22) Filed: Dec. 11, 2025

(30) Foreign Application Priority Data
Dec. 13, 2024 (TW) 113213806

(51) Int. Cl. H01R 13/64

(52) U.S. Cl. CPC H01R 13/64

(57) ABSTRACT

A connector assembly and male connector thereof are provided, the connector assembly comprising a female electrical connector, and the male connector being engaged with the female electrical connector to provide electrical signal transmission for electrical equipment. The male connector comprises a core engaging foolproof wall, the core engaging foolproof wall configured to abut the female electrical connector when the male connector engages with the female electrical connector in an incorrect direction so as to prevent the male connector from engaging with the female electrical connector in the wrong direction and thereby causing an abnormality.

### CROSS-REFERENCE TO RELATED APPLICATIONS

This application claims the priority of Republic of China Patent Application No. 113213806 filed on Dec. 13, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a connector assembly and male connector and female connector thereof, which can avoid abnormal electrical signal transmission caused by an incorrect engaging direction in which the male connector is engaged with the female connector.

### Descriptions of the Related Art

In an electrical device, it is often necessary to transmit electrical signals through a connector assembly composed of a female connector and a male connector. When the connector assembly is in use, the male connector is engaged with the female connector to provide transmission of the electrical signals for the electrical device.

However, engagement of the male connector with the female connector is usually directional. If such an engaging direction of the male connector is incorrect, it may cause abnormal electrical signal transmission through the connector assembly, thereby resulting in the electrical device failing to operate normally.

Therefore, how to provide a connector assembly and male connector and female connector thereof to avoid an incorrect engaging direction of the male connector with respect to the female connector is indeed a problem urgently to be solved by those skilled in the art.

### SUMMARY OF THE INVENTION

In view of the drawbacks of the prior art mentioned above, the present application provides a male connector configured to engage a female connector in a predetermined engaging direction, the male connector comprising: a male insulation core comprising a first male core engaging head, wherein the first male core engaging head is a protrusion on the male insulation core; wherein, when the male connector is engaged with the female connector in the engaging direction, the first male core engaging head is configured to be received in the female connector; and when the male connector is engaged with the female connector in a direction other than the engaging direction, the first male core engaging head is configured to abut the female connector to provide a foolproof mechanism for preventing the first male core engaging head from entering the female connector.

Preferably, the male connector said above, wherein the first male core engaging head comprises a first male core foolproof structure and a first male core engaging structure; when the male connector is engaged with the female connector in the engaging direction, the first male core foolproof structure is configured to enter the female connector to guide the first male core engaging structure into the female connector; when the male connector is engaged with the female connector in a direction other than the engaging direction, the first male core foolproof structure is configured to abut the female connector to provide the foolproof mechanism for preventing the first male core engaging structure from entering the female connector.

Preferably, the male connector said above, wherein the male insulation core further comprises a second male core engaging head, and the second male core engaging head is a protrusion on the male insulation core; wherein, when the male connector is engaged with the female connector in the engaging direction, the first male core foolproof structure is configured to enter the female connector to guide the second male core engaging head into the female connector; and when the male connector is engaged with the female connector in a direction other than the engaging direction, the first male core engaging head is configured to abut the female connector to provide the foolproof mechanism for preventing the second male core engaging head from entering the female connector.

Preferably, the male connector said above, wherein the second male core engaging head comprises a second male core engaging structure; when the male connector is engaged with the female connector in the engaging direction, the first male core foolproof structure is configured to enter the female connector to guide the first male core engaging structure and the second male core engaging structure respectively into the female connector; when the male connector is engaged with the female connector in a direction other than the engaging direction, the first male core foolproof structure is configured to abut the female connector to provide the foolproof mechanism for preventing the first male core engaging structure and the second male core engaging structure from entering the female connector.

Preferably, the male connector said above, wherein the first male core foolproof structure is a strip-shaped structure, and the first male core engaging structure and the second male core engaging structure are frame-shaped structures.

Preferably, the male connector said above, wherein the first male core engaging structure and the second male core engaging structure are substantially the same, and the first male core foolproof structure is connected to the first male core engaging structure.

Preferably, the male connector said above, wherein the male connector further comprises: a male conductive terminal set comprising a first male conductive terminal and a second male conductive terminal, wherein the first male conductive terminal comprises a first male terminal engaging structure and a first male terminal positioning structure, and the second male conductive terminal comprises a second male terminal engaging structure and a second male terminal positioning structure; the male insulation core further comprises a first male core positioning space, a second male core positioning space, a first male core positioning structure, and a second male core positioning structure; wherein the male conductive terminal set is configured to be inserted into the male insulation core, such that the first male terminal engaging structure and the second male terminal engaging structure are configured to respectively enter the first male core engaging head and the second male core engaging head to provide engagement with the female connector, and the first male terminal positioning structure is configured to enter the first male core positioning space and cooperate with the first male core positioning structure to position the first male terminal engaging structure in the first male core engaging head, and the second male terminal positioning structure is configured to enter the second male core positioning space and cooperate with the second male core positioning structure to position the second male terminal engaging structure in the second male core engaging head.

Preferably, the male connector said above, wherein the male insulation core further comprises a first male core terminal insertion elastic arm and a second male core terminal insertion elastic arm, wherein the first male core positioning structure is disposed on the first male core terminal insertion elastic arm, and the second male core positioning structure is disposed on the second male core terminal insertion elastic arm; when the male conductive terminal set is being inserted into the male insulation core, the first male conductive terminal and the second male conductive terminal are configured to respectively abut the first male core terminal insertion elastic arm and the second male core terminal insertion elastic arm to force the first and second male core terminal insertion elastic arms to elastically deform, so as to allow the first male terminal engaging structure and the second male terminal engaging structure to respectively be received in the first male core engaging head and the second male core engaging head, and allow the first male terminal positioning structure and the second male terminal positioning structure to respectively be received in the first male core positioning space and the second male core positioning space; thereafter, the first male conductive terminal and the second male conductive terminal are respectively released from abutting the first male core terminal insertion elastic arm and the second male core terminal insertion elastic arm, and the first and second male core terminal insertion elastic arms restore their shapes, so as to allow the first male core positioning structure to enter the first male core positioning space and cooperate with the first male terminal positioning structure to position the first male terminal engaging structure in the first male core engaging head, and allow the second male core positioning structure to enter the second male core positioning space and cooperate with the second male terminal positioning structure to position the second male terminal engaging structure in the second male core engaging head.

Preferably, the male connector said above, wherein the male connector further comprises a male terminal stop component mounted on the male insulation core, the male terminal stop component comprising a first male terminal stop structure and a second male terminal stop structure, wherein the first male terminal stop structure is configured to cooperate with the first male terminal positioning structure to position the first male terminal engaging structure in the first male core engaging head, and the second male terminal stop structure is configured to cooperate with the second male terminal positioning structure to position the second male terminal engaging structure in the second male core engaging head.

Preferably, the male connector said above, wherein the male terminal stop component further comprises a male terminal stop component fastening structure fastened to the male insulation core and configured to keep the male terminal stop component mounted on the male insulation core.

Additionally, the present application provides a female connector for use with a male connector, the male connector comprising a male connector foolproof portion and a male connector engaging portion and configured to engage the female connector in a predetermined engaging direction, the female connector comprising: a female insulation core comprising a first female core engaging port, wherein the first female core engaging port is a recess in the female insulation core; wherein, when the male connector is engaged with the female connector in the engaging direction, the male connector foolproof portion is configured to enter the first female core engaging port to guide the male connector engaging portion into the first female core engaging port; and when the male connector is engaged with the female connector in a direction other than the engaging direction, the female insulation core is configured to abut the male connector foolproof portion to provide a foolproof mechanism for preventing the male connector engaging portion from entering the first female core engaging port.

Preferably, the female connector said above, wherein the first female core engaging port comprises a first female core foolproof space and a first female core engaging space; when the male connector is engaged with the female connector in the engaging direction, the male connector foolproof portion is configured to enter the first female core foolproof space to guide the male connector engaging portion into the first female core engaging space; when the male connector is engaged with the female connector in a direction other than the engaging direction, the female insulation core is configured to abut the male connector foolproof portion to provide the foolproof mechanism for preventing the male connector foolproof portion from entering the first female core foolproof space, thereby preventing the male connector engaging portion from entering the first female core engaging space.

Preferably, the female connector said above, wherein the female insulation core further comprises a second female core engaging port, wherein the second female core engaging port is a protrusion on the female insulation core; wherein, when the male connector is engaged with the female connector in the engaging direction, the male connector foolproof portion is configured to enter the first female core foolproof space to guide the male connector engaging portion into the second female core engaging port; and when the male connector is engaged with the female connector in a direction other than the engaging direction, the female insulation core is configured to abut the male connector foolproof portion to provide the foolproof mechanism for preventing the male connector engaging portion from entering the second female core engaging port.

Preferably, the female connector said above, wherein the second female core engaging port comprises a second female core engaging space; when the male connector is engaged with the female connector in the engaging direction, the male connector foolproof portion is configured to enter the first female core foolproof space to guide the male connector engaging portion into the first female core engaging space and the second female core engaging space; and when the male connector is engaged with the female connector in a direction other than the engaging direction, the first female core engaging port is configured to abut the male connector foolproof portion to provide the foolproof mechanism for preventing the male connector foolproof portion from entering the first female core foolproof space, thereby preventing the male connector engaging portion from entering the first female core engaging space and the second female core engaging space.

Preferably, the female connector said above, wherein the first female core engaging space and the second female core engaging space are substantially the same, and the first female core foolproof space is in continuity with the first female core engaging space.

Additionally, the present application provides a connector assembly comprising: a female connector comprising a female insulation core, the female insulation core comprising a first female core foolproof space and a first female core engaging space; and a male connector configured to engage the female connector in a predetermined engaging direction, the male connector comprising a male insulation core, the male insulation core comprising a first male core foolproof structure and a first male core engaging structure; wherein, when the male connector is engaged with the female connector in the engaging direction, the first male core foolproof structure is configured to enter the first female core foolproof space to guide the first male core engaging structure into the first female core engaging space; and when the male connector is engaged with the female connector in a direction other than the engaging direction, the first male core foolproof structure is configured to abut the female insulation core to provide a foolproof mechanism for preventing the first male core foolproof structure from entering the first female core foolproof space, thereby preventing the first male core engaging structure from entering the first female core engaging space.

Preferably, the connector assembly said above, wherein the female insulation core further comprises a second female core engaging space, and the male insulation core further comprises a second male core engaging structure; wherein, when the male connector is engaged with the female connector in the engaging direction, the first male core foolproof structure is configured to enter the first female core foolproof space to guide the second male core engaging structure into the second female core engaging space; and when the male connector is engaged with the female connector in a direction other than the engaging direction, the first male core foolproof structure is configured to abut the female insulation core to provide the foolproof mechanism for preventing the second male core engaging structure from entering the second female core engaging space.

Preferably, the connector assembly said above, wherein the first female core engaging space and the second female core engaging space are substantially the same, and the first female core foolproof space is in continuity with the first female core engaging space; the first male core engaging structure and the second male core engaging structure are substantially the same, and the first male core foolproof structure is connected to the first male core engaging structure.

Compared with the prior art, the present application provides a connector assembly and male connector and female connector thereof. The male connector comprises a foolproof portion and is engaged with the female connector. When the male connector is engaged with the female connector in the correct direction, the foolproof portion of the male connector guides the male connector to engage with the female connector. When the male connector is engaged with the female connector in an incorrect direction, the foolproof portion of the male connector is configured to abut the female connector to provide foolproof so as to prevent the male connector from engaging with the female connector. In this way, it is possible to prevent an abnormality caused by the male connector being engaged with the female electrical connector in the wrong direction, and the male connector is engaged with the female connector in the correct direction to provide electrical signal transmission.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of a connector assembly of the present application from a first viewing angle in one embodiment.

FIG. 2 is a perspective schematic view of the connector assembly of the present application from a second viewing angle in one embodiment.

FIG. 3 is a perspective schematic view of the connector assembly of the present application from a first viewing angle in one embodiment.

FIG. 4 is a perspective schematic view of the connector assembly of the present application from a second viewing angle in one embodiment.

FIG. 5 is a top view schematic diagram of the connector assembly of the present application in one embodiment.

FIG. 6 is a cross-sectional schematic view of a portion of the connector assembly shown in FIG. 5 taken along line AA.

FIG. 7 is a side view schematic diagram of the connector assembly of the present application in one embodiment.

FIG. 8 is a cross-sectional schematic view of a portion of the connector assembly shown in FIG. 7 taken along line BB.

FIG. 9 is a perspective schematic view of a connector assembly of the present application from a first viewing angle in one embodiment.

FIG. 10 is a perspective schematic view of the connector assembly of the present application from a second viewing angle in one embodiment.

FIG. 11 is a cross-sectional schematic view of the male connector of the present application in one embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In addition, it should be noted that, for the sake of brevity and ease of understanding, components having the same or similar functions in the following embodiments will be denoted by the same reference numerals, and descriptions of identical or equivalent features will be omitted.

The present application provides a connector assembly and male connector and female connector thereof, the male connector comprises a foolproof portion, when the male connector is engaged with the female connector in an incorrect direction, the foolproof portion of the male connector is abutted against the female connector to provide foolproof so as to prevent the male connector from engaging the female connector. In this way, it is possible to prevent the male connector from engaging the female connector in the wrong direction to cause an abnormality, and the male connector can engage the female connector in the correct direction to provide electrical signal transmission.

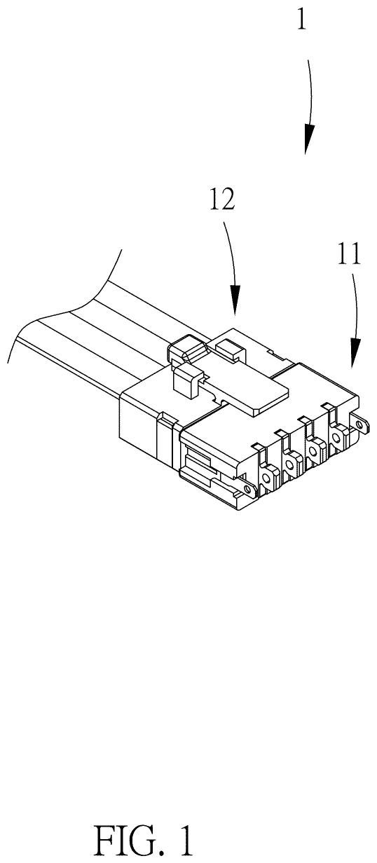

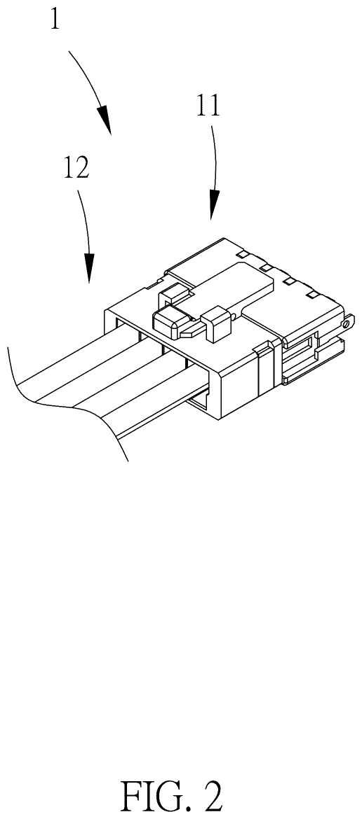

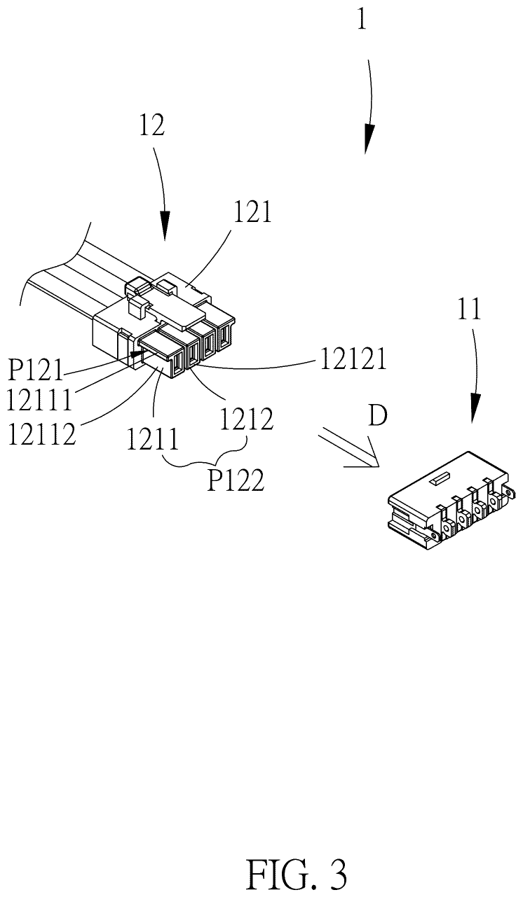

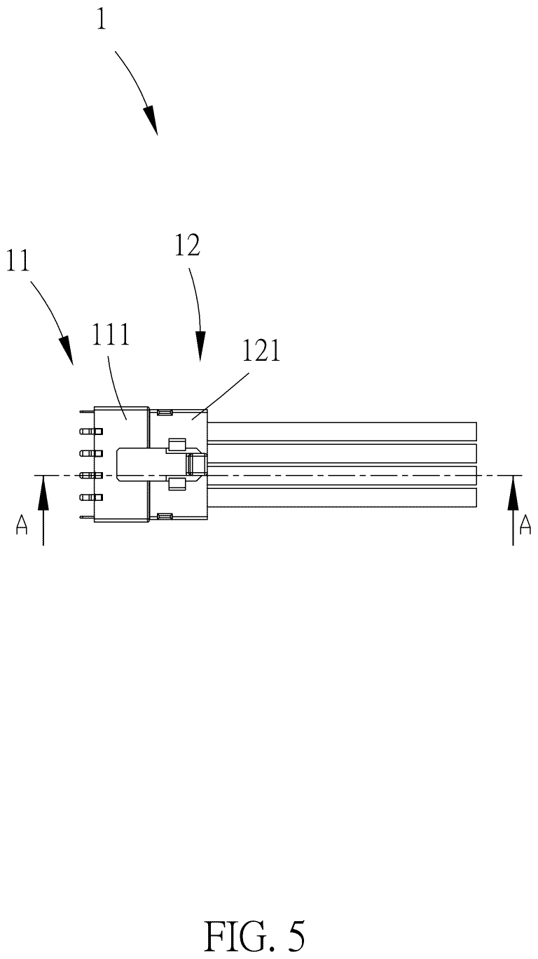

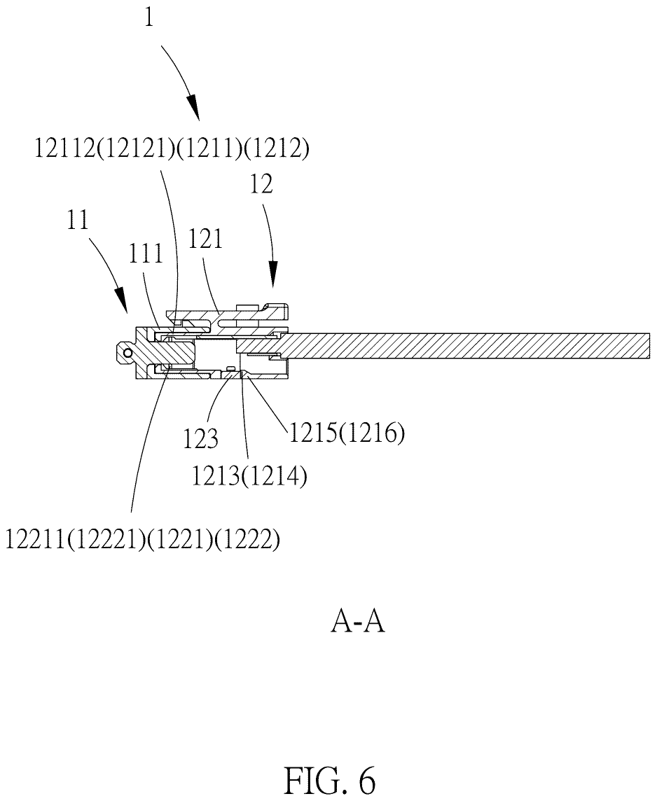

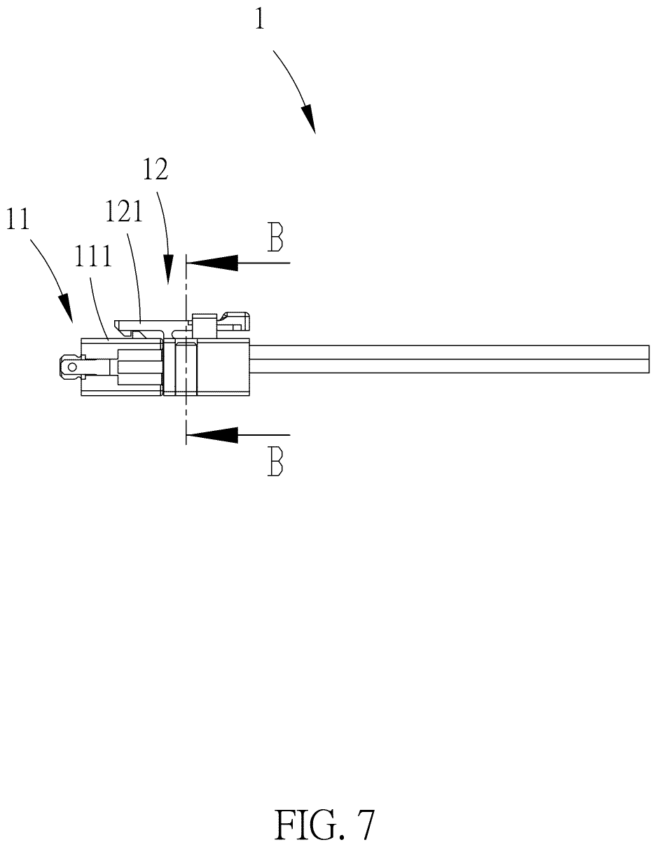

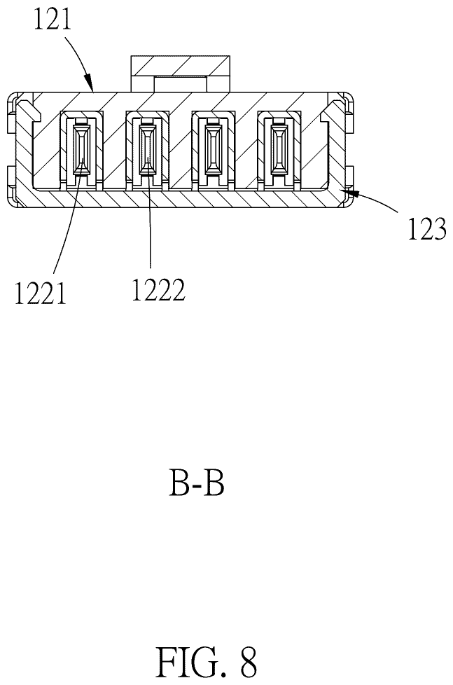

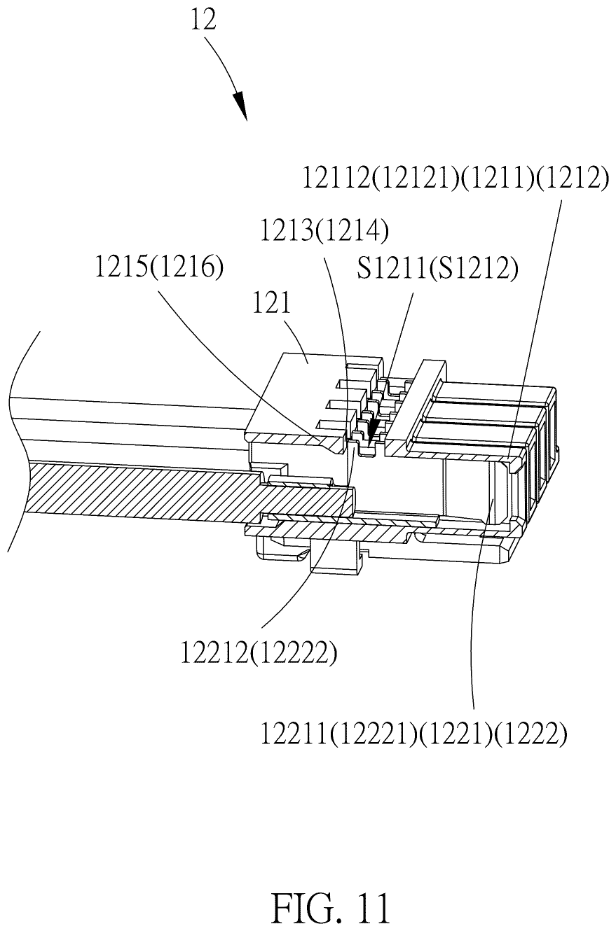

For a detailed description of the embodiments disclosed in the present application, please refer to FIGS. 1 to 11.

In the embodiments shown in FIGS. 1 to 10, at least one connector assembly 1 is provided for being disposed in electrical equipment to provide electrical signal transmission, the connector assembly 1 comprises: a female connector 11 and a male connector 12. The male connector 12 is engaged with the female connector 11 in an engaging direction D, so that the male connector 12 and the female connector 11 are electrically connected to provide electrical signal transmission for the electrical equipment.

Regarding the female connector 11, the female connector 11 comprises: a female insulation core 111 comprising a first female core engaging port 1111 and a second female core engaging port 1112, wherein the first female core engaging port 1111 and the second female core engaging port 1112 are recesses in the female insulation core 111. Wherein, the first female core engaging port 1111 comprises a first female core foolproof space S11111 and a first female core engaging space S11112; and the second female core engaging port 1112 comprises a second female core engaging space S11121.

Regarding the male connector 12, the male connector 12 comprises a male connector engaging portion P122 and a male connector foolproof portion P121, and the male connector 12 comprises: a male insulation core 121, the male insulation core 121 comprises a first male core engaging head 1211 and a second male core engaging head 1212, wherein the first male core engaging head 1211 and the second male core engaging head 1212 are protrusions on the male insulation core 121.

For the first male core engaging head 1211, the first male core engaging head 1211 comprises a first male core foolproof structure 12111 and a first male core engaging structure 12112, wherein the first male core foolproof structure 12111 and the first male core engaging structure 12112 are respectively disposed on the male connector foolproof portion P121 and the male connector engaging portion P122.

For the second male core engaging head 1212, the second male core engaging head 1212 comprises a second male core engaging structure 12121, wherein the second male core engaging structure 12121 is disposed on the male connector engaging portion P122.

It should be noted that, when the male connector 12 is engaged with the female connector 11 in the engaging direction D, that is, when the male connector 12 is engaged with the female connector 11 in the correct direction, the male connector foolproof portion P121 and its first male core foolproof structure 12111 are inserted into the first female core engaging port 1111 and its first female core foolproof space S11111 to guide the first male core engaging head 1211 and the second male core engaging head 1212 into the female connector 11, so that the male connector engaging portion P122 enters the first female core engaging port 1111 and the second female core engaging port 1112, thereby allowing the first male core engaging structure 12112 and the second male core engaging structure 12121 to respectively enter the first female core engaging space S11112 and the second female core engaging space S11121, thereby achieving that the male connector 12 is engaged with the female connector 11 so that the connector assembly 1 provides electrical signal transmission as expected.

In addition, when the male connector 12 is engaged with the female connector 11 in a direction other than the engaging direction D, that is, when the male connector 12 is engaged with the female connector 11 in an incorrect direction, the male connector foolproof portion P121 and its first male core foolproof structure 12111 are abutted against the female insulation core 111 to prevent the male connector foolproof portion P121 from entering the first female core engaging port 1111 and its first female core foolproof space S11111, and to prevent the male connector engaging portion P122 from entering the first female core engaging port 1111 and the second female core engaging port 1112, thereby preventing the first male core engaging structure 12112 and the second male core engaging structure 12121 from respectively entering the first female core engaging space S11112 and the second female core engaging space S11121, that is, at this time, the first male core engaging head 1211 and its first male core foolproof structure 12111 are abutted against the female connector 11 to provide foolproof so as to prevent the first male core engaging head 1211 and its first male core engaging structure 12112 and the second male core engaging head 1212 and its second male core engaging structure 12121 from entering the female connector 11. In this way, it is possible to avoid abnormal electrical signal transmission caused by the male connector 12 and the female connector 11 being engaged in the wrong direction.

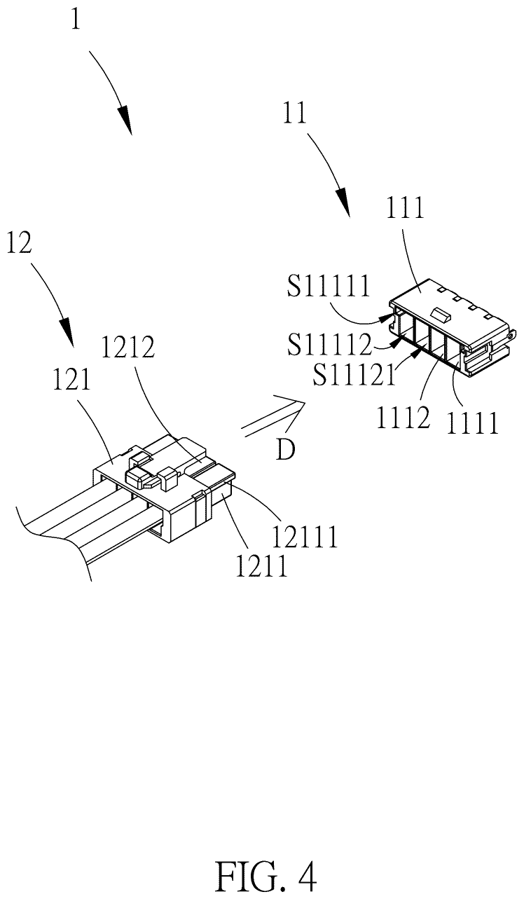

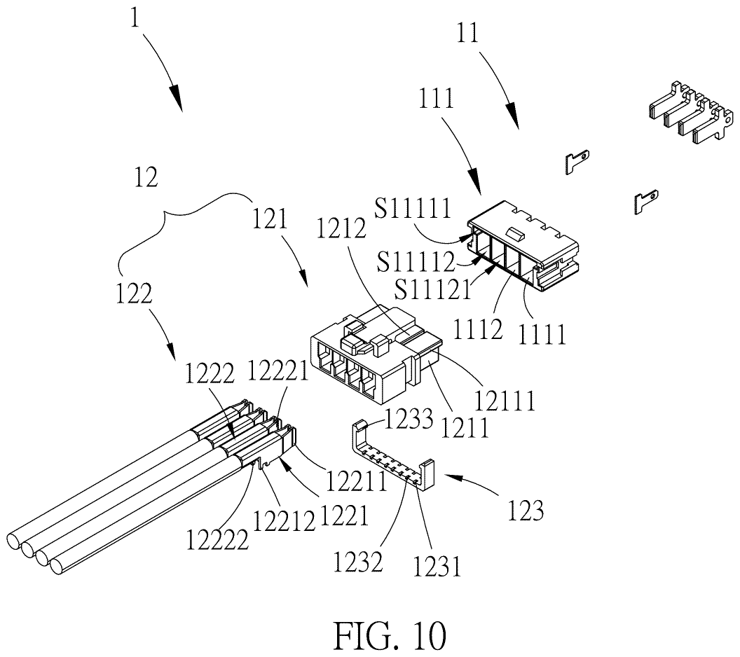

In the embodiments shown in FIGS. 4 and 10, the first male core foolproof structure 12111 is a strip-shaped structure to cooperate with the structural design of the first female core engaging port 1111 and its first female core foolproof space S11111; and the first male core engaging structure 12112 and the second male core engaging structure 12121 are frame-shaped structures to cooperate with the structural design of the first female core engaging space S11112 and the second female core engaging space S11121. In addition, the first male core engaging structure 12112 and the second male core engaging structure 12121 are substantially the same to cooperate with the structural design of the first female core engaging space S11112 and the second female core engaging space S11121; and the first male core foolproof structure 12111 is connected to the first male core engaging structure 12112 to enhance the structural strength of the first male core engaging head 1211.

In the embodiments shown in FIGS. 4 and 10, the first female core engaging space S11112 and the second female core engaging space S11121 are substantially the same to cooperate with the structural design of the first male core engaging structure 12112 and the second male core engaging structure 12121; and the first female core foolproof space S11111 is in continuity with the first female core engaging space S11112 to cooperate with the structural design of the first male core foolproof structure 12111 and the first male core engaging structure 12112.

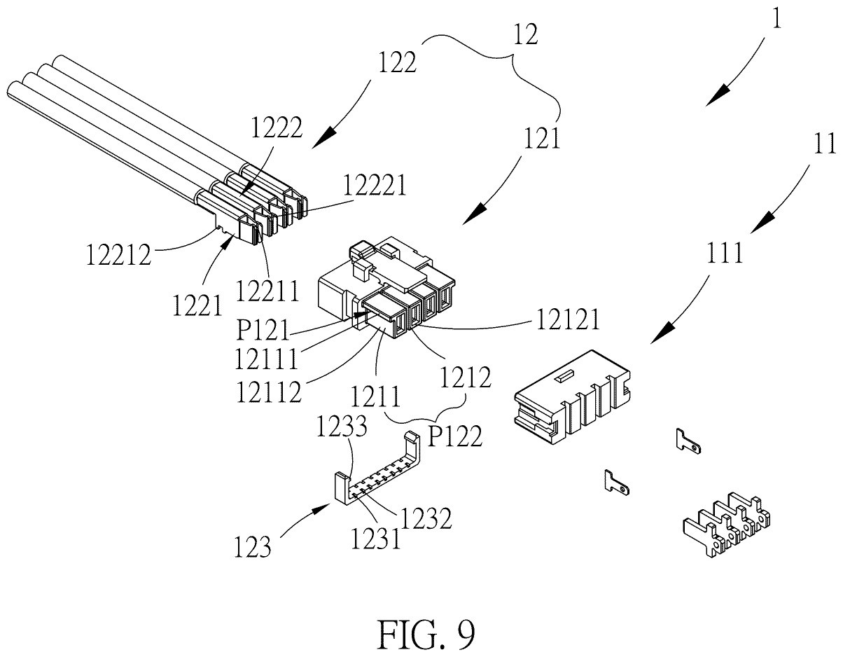

In the embodiments shown in FIGS. 9 to 10, the male connector 12 further comprises: a male conductive terminal set 122. The male conductive terminal set 122 is configured for transmitting electrical signals, and the male conductive terminal set 122 comprises a first male conductive terminal 1221 and a second male conductive terminal 1222. The first male conductive terminal 1221 comprises a first male terminal engaging structure 12211 and a first male terminal positioning structure 12212, and the second male conductive terminal 1222 comprises a second male terminal engaging structure 12221 and a second male terminal positioning structure 12222. Correspondingly, the male insulation core 121 further comprises a first male core positioning space S1211, a second male core positioning space S1212, a first male core positioning structure 1213, a second male core positioning structure 1214, a first male core terminal insertion elastic arm 1215, and a second male core terminal insertion elastic arm 1216, wherein the first male core positioning structure 1213 is disposed on the first male core terminal insertion elastic arm 1215, and the second male core positioning structure 1214 is disposed on the second male core terminal insertion elastic arm 1216.

It should be noted that, in the above embodiments, the male conductive terminal set 122 is received in the male insulation core 121, so that the first male terminal engaging structure 12211 and the second male terminal engaging structure 12221 are respectively inserted into the first male core engaging head 1211 and the second male core engaging head 1212 to provide engaging, and the first male terminal positioning structure 12212 is received in the first male core positioning space S1211 to cooperate with the first male core positioning structure 1213 so as to position the first male terminal engaging structure 12211 in the first male core engaging head 1211 and prevent the first male terminal engaging structure 12211 from disengaging from the first male core engaging head 1211, and the second male terminal positioning structure 12222 is received in the second male core positioning space S1212 to cooperate with the second male core positioning structure 1214 so as to position the second male terminal engaging structure 12221 in the second male core engaging head 1212 and prevent the second male terminal engaging structure 12221 from disengaging from the second male core engaging head 1212.

In addition, it should be noted that, during the process in which the male conductive terminal set 122 is received in the male insulation core 121, first, the first male conductive terminal 1221 and the second male conductive terminal 1222 are respectively abutted against the first male core terminal insertion elastic arm 1215 and the second male core terminal insertion elastic arm 1216 so as to force the first male core terminal insertion elastic arm 1215 and the second male core terminal insertion elastic arm 1216 to elastically deform to respectively form a first male terminal insertion passage and a second male terminal insertion passage, whereby the first male conductive terminal 1221 and the second male conductive terminal 1222 are respectively inserted into the first male terminal insertion passage and the second male terminal insertion passage into the male insulation core 121, allowing the first male terminal engaging structure 12211 and the second male terminal engaging structure 12221 to respectively enter the first male core engaging head 1211 and the second male core engaging head 1212, and allowing the first male terminal positioning structure 12212 and the second male terminal positioning structure 12222 to respectively enter the first male core positioning space S1211 and the second male core positioning space S1212; thereafter, the first male conductive terminal 1221 and the second male conductive terminal 1222 are respectively released from abutting against the first male core terminal insertion elastic arm 1215 and the second male core terminal insertion elastic arm 1216, such that the first male core terminal insertion elastic arm 1215 and the second male core terminal insertion elastic arm 1216 restore, the first male terminal insertion passage and the second male terminal insertion passage disappear, and the first male core positioning structure 1213 enters the first male core positioning space S1211 to cooperate with the first male terminal positioning structure 12212 to position the first male terminal engaging structure 12211 in the first male core engaging head 1211, and the second male core positioning structure 1214 enters the second male core positioning space S1212 to cooperate with the second male terminal positioning structure 12222 to position the second male terminal engaging structure 12221 in the second male core engaging head 1212. In this way, it is possible to avoid the male conductive terminal set 122 falling off from the male insulation core 121 during use, thereby extending the service life of the male connector 12.

In the embodiments shown in FIGS. 9 to 10, the male connector 12 further comprises: a male terminal stop component 123. The male terminal stop component 123 comprises a first male terminal stop structure 1231, a second male terminal stop structure 1232, and a male terminal stop component fastening structure 1233. The male terminal stop component 123 is mounted on the male insulation core 121 so that the first male terminal stop structure 1231 cooperates with the first male terminal positioning structure 12212 to position the first male terminal engaging structure 12211 in the first male core engaging head 1211, and the second male terminal stop structure 1232 cooperates with the second male terminal positioning structure 12222 to position the second male terminal engaging structure 12221 in the second male core engaging head 1212, and the male terminal stop component fastening structure 1233 is fastened to the male insulation core 121 to maintain the male terminal stop component 123 mounted on the male insulation core 121. In this way, by the stopping action of the male terminal stop component 123, it is possible to avoid the male conductive terminal set 122 from falling off from the male insulation core 121 during use, thereby extending the service life of the male connector 12.

It should be noted that, the connector assembly of the present application and male connector and female connector thereof may also omit or adjust the design of components and are not limited to the above. For example, the connector assembly of the present application may optionally comprise: a female connector and a male connector. The female connector comprises: a female insulation core, and the female insulation core comprises a first female core foolproof space and a first female core engaging space. The male connector is engaged with the female connector in an engaging direction, and the male connector comprises: a male insulation core, and the male insulation core comprises a first male core foolproof structure and a first male core engaging structure; wherein, when the male connector is engaged with the female connector in the engaging direction, the first male core foolproof structure is received in the first female core foolproof space to guide the first male core engaging structure into the first female core engaging space; and when the male connector is engaged with the female connector in a direction other than the engaging direction, the first male core foolproof structure is abutted against the male insulation core to provide foolproof so as to prevent the first male core foolproof structure from entering the first female core foolproof space, thereby preventing the first male core engaging structure from entering the first female core engaging space.

In addition, the male connector of the present application may optionally comprise: a male insulation core comprising a first male core engaging head, wherein the first male core engaging head is a protrusion on the male insulation core; wherein, when the male connector is engaged with the female connector in the engaging direction, the first male core engaging head is received in the female connector; and when the male connector is engaged with the female connector in a direction other than the engaging direction, the first male core engaging head is abutted against the female connector to provide foolproof so as to prevent the first male core engaging head from entering the female connector and thereby provide foolproof.

Furthermore, the female connector of the present application may optionally comprise: a female insulation core comprising a first female core engaging port, wherein the first female core engaging port is a recess in the female insulation core; wherein, when the male connector is engaged with the female connector in the engaging direction, the male connector foolproof portion is received in the first female core engaging port to guide the male connector engaging portion into the female core engaging port; and when the male connector is engaged with the female connector in a direction other than the engaging direction, the female insulation core is abutted against the male connector foolproof portion to provide foolproof so as to prevent the male connector engaging portion from entering the first female core engaging port.

In summary, the present application provides a connector assembly and male connector and female connector thereof. The male connector comprises a foolproof portion, and the male connector is engaged with the female connector. When the male connector is engaged with the female connector in the correct direction, the foolproof portion of the male connector can guide the male connector to engage the female connector; when the male connector is engaged with the female connector in an incorrect direction, the foolproof portion of the male connector is abutted against the female connector to provide foolproof so as to prevent the male connector from engaging the female connector. In this way, it is possible to prevent an abnormality caused by the male connector being engaged with the female electrical connector in the wrong direction, and the male connector is engaged with the female connector in the correct direction to provide electrical signal transmission.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A male connector configured to engage a female connector in a predetermined engaging direction, the male connector comprising:
a male insulation core comprising a first male core engaging head, wherein the first male core engaging head is a protrusion on the male insulation core; wherein,
when the male connector is engaged with the female connector in the engaging direction, the first male core engaging head is configured to be received in the female connector; and
when the male connector is engaged with the female connector in a direction other than the engaging direction, the first male core engaging head is configured to abut the female connector to provide a foolproof mechanism for preventing the first male core engaging head from entering the female connector.

2. The male connector according to claim 1, wherein the first male core engaging head comprises a first male core foolproof structure and a first male core engaging structure;
when the male connector is engaged with the female connector in the engaging direction, the first male core foolproof structure is configured to enter the female connector to guide the first male core engaging structure into the female connector;
when the male connector is engaged with the female connector in a direction other than the engaging direction, the first male core foolproof structure is configured to abut the female connector to provide the foolproof mechanism for preventing the first male core engaging structure from entering the female connector.

3. The male connector according to claim 2, wherein the male insulation core further comprises a second male core engaging head, and the second male core engaging head is a protrusion on the male insulation core; wherein,
when the male connector is engaged with the female connector in the engaging direction, the first male core foolproof structure is configured to enter the female connector to guide the second male core engaging head into the female connector; and
when the male connector is engaged with the female connector in a direction other than the engaging direction, the first male core engaging head is configured to abut the female connector to provide the foolproof mechanism for preventing the second male core engaging head from entering the female connector.

4. The male connector according to claim 3, wherein the second male core engaging head comprises a second male core engaging structure;
when the male connector is engaged with the female connector in the engaging direction, the first male core foolproof structure is configured to enter the female connector to guide the first male core engaging structure and the second male core engaging structure respectively into the female connector;
when the male connector is engaged with the female connector in a direction other than the engaging direction, the first male core foolproof structure is configured to abut the female connector to provide the foolproof mechanism for preventing the first male core engaging structure and the second male core engaging structure from entering the female connector.

5. The male connector according to claim 4, wherein the first male core foolproof structure is a strip-shaped structure, and the first male core engaging structure and the second male core engaging structure are frame-shaped structures.

6. The male connector according to claim 4, wherein the first male core engaging structure and the second male core engaging structure are substantially the same, and the first male core foolproof structure is connected to the first male core engaging structure.

7. The male connector according to claim 3, wherein the male connector further comprises: a male conductive terminal set comprising a first male conductive terminal and a second male conductive terminal, wherein the first male conductive terminal comprises a first male terminal engaging structure and a first male terminal positioning structure, and the second male conductive terminal comprises a second male terminal engaging structure and a second male terminal positioning structure; the male insulation core further comprises a first male core positioning space, a second male core positioning space, a first male core positioning structure, and a second male core positioning structure; wherein the male conductive terminal set is configured to be inserted into the male insulation core, such that the first male terminal engaging structure and the second male terminal engaging structure are configured to respectively enter the first male core engaging head and the second male core engaging head to provide engagement with the female connector, and the first male terminal positioning structure is configured to enter the first male core positioning space and cooperate with the first male core positioning structure to position the first male terminal engaging structure in the first male core engaging head, and the second male terminal positioning structure is configured to enter the second male core positioning space and cooperate with the second male core positioning structure to position the second male terminal engaging structure in the second male core engaging head.

8. The male connector according to claim 7, wherein the male insulation core further comprises a first male core terminal insertion elastic arm and a second male core terminal insertion elastic arm, wherein the first male core positioning structure is disposed on the first male core terminal insertion elastic arm, and the second male core positioning structure is disposed on the second male core terminal insertion elastic arm; when the male conductive terminal set is being inserted into the male insulation core, the first male conductive terminal and the second male conductive terminal are configured to respectively abut the first male core terminal insertion elastic arm and the second male core terminal insertion elastic arm to force the first and second male core terminal insertion elastic arms to elastically deform, so as to allow the first male terminal engaging structure and the second male terminal engaging structure to respectively be received in the first male core engaging head and the second male core engaging head, and allow the first male terminal positioning structure and the second male terminal positioning structure to respectively be received in the first male core positioning space and the second male core positioning space; thereafter, the first male conductive terminal and the second male conductive terminal are respectively released from abutting the first male core terminal insertion elastic arm and the second male core terminal insertion elastic arm, and the first and second male core terminal insertion elastic arms restore their shapes, so as to allow the first male core positioning structure to enter the first male core positioning space and cooperate with the first male terminal positioning structure to position the first male terminal engaging structure in the first male core engaging head, and allow the second male core positioning structure to enter the second male core positioning space and cooperate with the second male terminal positioning structure to position the second male terminal engaging structure in the second male core engaging head.

9. The male connector according to claim 7, wherein the male connector further comprises a male terminal stop component mounted on the male insulation core, the male terminal stop component comprising a first male terminal stop structure and a second male terminal stop structure, wherein the first male terminal stop structure is configured to cooperate with the first male terminal positioning structure to position the first male terminal engaging structure in the first male core engaging head, and the second male terminal stop structure is configured to cooperate with the second male terminal positioning structure to position the second male terminal engaging structure in the second male core engaging head.

10. The male connector according to claim 9, wherein the male terminal stop component further comprises a male terminal stop component fastening structure fastened to the male insulation core and configured to keep the male terminal stop component mounted on the male insulation core.

11. A female connector for use with a male connector, the male connector comprising a male connector foolproof portion and a male connector engaging portion and configured to engage the female connector in a predetermined engaging direction, the female connector comprising:
a female insulation core comprising a first female core engaging port, wherein the first female core engaging port is a recess in the female insulation core; wherein,
when the male connector is engaged with the female connector in the engaging direction, the male connector foolproof portion is configured to enter the first female core engaging port to guide the male connector engaging portion into the first female core engaging port; and
when the male connector is engaged with the female connector in a direction other than the engaging direction, the female insulation core is configured to abut the male connector foolproof portion to provide a foolproof mechanism for preventing the male connector engaging portion from entering the first female core engaging port.

12. The female connector according to claim 11, wherein the first female core engaging port comprises a first female core foolproof space and a first female core engaging space;
when the male connector is engaged with the female connector in the engaging direction, the male connector foolproof portion is configured to enter the first female core foolproof space to guide the male connector engaging portion into the first female core engaging space;
when the male connector is engaged with the female connector in a direction other than the engaging direction, the female insulation core is configured to abut the male connector foolproof portion to provide the foolproof mechanism for preventing the male connector foolproof portion from entering the first female core foolproof space, thereby preventing the male connector engaging portion from entering the first female core engaging space.

13. The female connector according to claim 12, wherein the female insulation core further comprises a second female core engaging port, wherein the second female core engaging port is a protrusion on the female insulation core; wherein,
when the male connector is engaged with the female connector in the engaging direction, the male connector foolproof portion is configured to enter the first female core foolproof space to guide the male connector engaging portion into the second female core engaging port; and
when the male connector is engaged with the female connector in a direction other than the engaging direction, the female insulation core is configured to abut the male connector foolproof portion to provide the foolproof mechanism for preventing the male connector engaging portion from entering the second female core engaging port.

14. The female connector according to claim 13, wherein the second female core engaging port comprises a second female core engaging space;
when the male connector is engaged with the female connector in the engaging direction, the male connector foolproof portion is configured to enter the first female core foolproof space to guide the male connector engaging portion into the first female core engaging space and the second female core engaging space; and
when the male connector is engaged with the female connector in a direction other than the engaging direction, the first female core engaging port is configured to abut the male connector foolproof portion to provide the foolproof mechanism for preventing the male connector foolproof portion from entering the first female core foolproof space, thereby preventing the male connector engaging portion from entering the first female core engaging space and the second female core engaging space.

15. The female connector according to claim 14, wherein the first female core engaging space and the second female core engaging space are substantially the same, and the first female core foolproof space is in continuity with the first female core engaging space.

16. A connector assembly comprising:
a female connector comprising a female insulation core, the female insulation core comprising a first female core foolproof space and a first female core engaging space; and
a male connector configured to engage the female connector in a predetermined engaging direction, the male connector comprising a male insulation core, the male insulation core comprising a first male core foolproof structure and a first male core engaging structure; wherein,
when the male connector is engaged with the female connector in the engaging direction, the first male core foolproof structure is configured to enter the first female core foolproof space to guide the first male core engaging structure into the first female core engaging space; and
when the male connector is engaged with the female connector in a direction other than the engaging direction, the first male core foolproof structure is configured to abut the female insulation core to provide a foolproof mechanism for preventing the first male core foolproof structure from entering the first female core foolproof space, thereby preventing the first male core engaging structure from entering the first female core engaging space.

17. The connector assembly according to claim 16, wherein the female insulation core further comprises a second female core engaging space, and the male insulation core further comprises a second male core engaging structure; wherein,
when the male connector is engaged with the female connector in the engaging direction, the first male core foolproof structure is configured to enter the first female core foolproof space to guide the second male core engaging structure into the second female core engaging space; and
when the male connector is engaged with the female connector in a direction other than the engaging direction, the first male core foolproof structure is configured to abut the female insulation core to provide the foolproof mechanism for preventing the second male core engaging structure from entering the second female core engaging space.

18. The connector assembly according to claim 17, wherein the first female core engaging space and the second female core engaging space are substantially the same, and the first female core foolproof space is in continuity with the first female core engaging space; the first male core engaging structure and the second male core engaging structure are substantially the same, and the first male core engaging structure is connected to the first male core engaging structure.
